(19) United States
(12) Patent Application Publication
(10) Pub. No.: US 2020/0319897 A1
(43) Pub. Date: Oct. 8, 2020

(54) HYPERCONVERGED SYSTEM INCLUDING A CORE LAYER, A USER INTERFACE, AND A SERVICES LAYER EQUIPPED WITH A CONTAINER-BASED USER SPACE

(71) Applicant: William Jason Turner, Leander, TX (US)

(72) Inventor: William Jason Turner, Leander, TX (US)

(21) Appl. No.: 16/304,255

(22) PCT Filed: May 19, 2017
(86) PCT No.: PCT/US17/33685

§ 371 Date: Nov. 23, 2018

Related U.S. Application Data
(60) Provisional application No. 62/340,508, filed on May 23, 2016.
(60) Provisional application No. 62/340,514, filed on May 23, 2016.
(60) Provisional application No. 62/340,520, filed on May 24, 2016.
(60) Provisional application No. 62/340,537, filed on May 24, 2016.

(51) Int. Cl. G06F 9/445; G06F 9/54; G06F 9/48; G06F 21/10; G06F 21/57; G06F 8/65; G06F 11/14; G06F 9/455

(52) U.S. Cl. CPC G06F 9/44505; G06F 9/545; G06F 9/485; G06F 21/10; G06F 21/57; G06F 2221/033; G06F 11/1438; G06F 11/1423; G06F 9/45558; G06F 2009/4557; G06F 8/65

(57) ABSTRACT

A hyperconverged system is provided which includes an operating system; a core layer equipped with hardware which starts and updates the operating system and which provides security features to the operating system; a services layer which provides services utilized by the operating system and which interfaces with the core layer by way of at least one application program interface; and a user interface layer which interfaces with the core layer by way of at least one application program interface; wherein said services layer is equipped with at least one user space having a plurality of containers.

### CROSS-REFERENCE TO RELATED APPLICATION

This application is a 371 PCT national application claiming priority to PCT/US17/33685, filed May 19, 2017, having the same title, and having the same inventor, and which is incorporated herein in by reference in its entirety; which claims the benefit of priority from U.S. Provisional Patent Application No. 62/340,508, filed May 23, 2016, having the same title, and having the same inventor, and which is incorporated herein by reference in its entirety, which also claims the benefit of priority from U.S. Provisional Patent Application No. 62/340,514, filed May 23, 2016, having the same title, and having the same inventor, and which is incorporated herein by reference in its entirety, which also claims the benefit of priority from U.S. Provisional Patent Application No. 62/340,520, filed May 24, 2016, having the same title, and having the same inventor, and which is incorporated herein by reference in its entirety, and which also claims the benefit of priority from U.S. Provisional Patent Application No. 62/340,537, filed May 24, 2016, having the same title, and having the same inventor, and which is incorporated herein by reference in its entirety.

### TECHNICAL FIELD OF THE INVENTION

The present invention pertains generally to hyperconverged systems, and more particularly to hyperconverged systems including a core layer, a services layer and a user interface.

### BACKGROUND OF THE INVENTION

Hyperconvergence is an IT infrastructure framework for integrating storage, networking and virtualization computing in a data center. In a hyperconverged infrastructure, all elements of the storage, compute and network components are optimized to work together on a single commodity appliance from a single vendor. Hyperconvergence masks the complexity of the underlying system and simplifies data center maintenance and administration. Moreover, because of the modularity that hyperconvergence offers, hyperconverged systems may be readily scaled out through the addition of further modules.

Virtual machines (VMs) and containers are integral parts of the hyper-converged infrastructure of modern data centers. VMs are emulations of particular computer systems that operate based on the functions and computer architecture of real or hypothetical computers. A VM is equipped with a full server hardware stack that has been virtualized. Thus, a VM includes virtualized network adapters, virtualized storage, a virtualized CPU, and a virtualized BIOS. Since VMs include a full hardware stack, each VM requires a complete operating system (OS) to function, and VM instantiation thus requires booting a full OS.

In contrast to VMs which provide abstraction at the physical hardware level (e.g., by virtualizing the entire server hardware stack), containers provide abstraction at the OS level. In most container systems, the user space is also abstracted. A typical example is application presentation systems such as the XenApp from Citrix. XenApp creates a segmented user space for each instance of an application. XenApp may be used, for example, to deploy an office suite to dozens or thousands of remote workers. In doing so, XenApp creates sandboxed user spaces on a Windows Server for each connected user. While each user shares the same OS instance including kernel, network connection, and base file system, each instance of the office suite has a separate user space.

Since containers do not require a separate kernel to be loaded for each user session, the use of containers avoids the overhead associated with multiple operating systems which is experienced with VMs. Consequently, containers typically use less memory and CPU than VMs running similar workloads. Moreover, because containers are merely sandboxed environments within an operating system, the time required to initiate a container is typically very small.

### SUMMARY OF THE INVENTION

In one aspect, a hyperconverged system is provided which comprises a plurality of containers, wherein each container includes a virtual machine (VM) and a virtualization solution module.

In another aspect, a method is provided for implementing a hyperconverged system. The method comprises (a) providing at least one server; and (b) implementing a hyperconverged system on the at least one server by loading a plurality of containers onto a memory device associated with the server, wherein each container includes a virtual machine (VM) and a virtualization solution module.

In a further aspect, tangible, non-transient media is provided having suitable programming instructions recorded therein which, when executed by one or more computer processors, performs any of the foregoing methods, or facilitates or establishes any of the foregoing systems.

In yet another aspect, a hyper-converged system is provided which comprises an operating system; a core layer equipped with hardware which starts and updates the operating system and which provides security features to the operating system; a services layer which provides services utilized by the operating system and which interfaces with the core layer by way of at least one application program interface; and a user interface layer which interfaces with the core layer by way of at least one application program interface; wherein said services layer is equipped with at least one user space having a plurality of containers.

In still another aspect, a hyper-converged system is provided which comprises (a) an operating system; (b) a core layer equipped with hardware which starts and updates the operating system and which provides security features to the operating system; (c) a services layer which provides services utilized by the operating system and which interfaces with the core layer by way of at least one application program interface; and (d) a user interface layer which interfaces with the core layer by way of at least one application program interface; wherein said core layer includes a system level, and wherein said system level comprises an operating system kernel.

In another aspect, a hyper-converged system is provided which comprises (a) an orchestrator which installs and coordinates container pods on a cluster of container hosts; (b) a plurality of containers installed by said orchestrator and running on a host operating system kernel cluster; and (c) a configurations database in communication with said orchestrator by way of an application programming interface, wherein said configurations database provides shared configuration and service discovery for said cluster, and wherein said configurations database is readable and writable by containers installed by said orchestrator.

### BRIEF DESCRIPTION OF THE DRAWINGS

For a more complete understanding of the present invention and the advantages thereof, reference is now made to the following description taken in conjunction with the accompanying drawings in which like reference numerals indicate like features.

FIG. 1 is an illustration of the system architecture of a system in accordance with the teachings herein.

FIG. 2 is an illustration of the system level module of FIG. 1.

FIG. 3 is an illustration of the provision services module of FIG. 1.

FIG. 4 is an illustration of the core/service module of FIG. 1.

FIG. 5 is an illustration of the persistent storage module of FIG. 1.

FIG. 6 is an illustration of the user space containers module of FIG. 1.

FIG. 7 is an illustration of the management services module of FIG. 1.

FIG. 8 is an illustration of the added value services module of FIG. 1.

FIG. 9 is an illustration of the management system module of FIG. 1.

### DETAILED DESCRIPTION OF THE INVENTION

Recently, the concept of running VMs inside of containers has emerged in the art. The resulting VM containers have the look and feel of conventional containers, but offer several advantages over VMs and conventional containers. The use of Docker containers is especially advantageous. Docker is an open-source project that automates the deployment of applications inside software containers by providing an additional layer of abstraction and automation of operating-system-level virtualization on Linux. For example, Docker containers retain the isolation and security properties of VMs, while still allowing software to be packaged and distributed as containers. Docker containers also permit on-boarding of existing workloads, which is a frequent challenge for organizations wishing to adopt container-based technologies.

KVM (for Kernel-based Virtual Machine) is a full virtualization solution for Linux on x86 hardware containing virtualization extensions (Intel VT or AMD-V). It consists of a loadable kernel module (kvm.ko) that provides the core virtualization infrastructure, and a processor specific module (kvm-intel.ko or kvm-amd.ko). Using KVM, one can run multiple virtual machines running unmodified Linux or Windows images. Each virtual machine has private virtualized hardware (e.g., a network card, disk, graphics adapter, and the like). The kernel component of KVM is included in mainline Linux, and the userspace component of KVM is included in mainline QEMU (Quick Emulator, a hosted hypervisor that performs hardware virtualization).

One existing system which utilizes VM containers is the RancherVM system, which runs KVM inside Docker containers, and which is available at https://github.com/rancher/vm. RancherVM provides useful management tools for open source virtualization technologies such as KVM. However, while the RancherVM system has some desirable attributes, it also contains a number of infirmities.

For example, the RancherVM system uses the KVM module on the host operating system. This creates a single point of failure and security vulnerability for the entire host, in that compromising the KVM module compromises the entire host. This arrangement also complicates updates, since the host operating system must be restarted in order for updates to be effected (which, in turn, requires all virtual clients to be stopped). Moreover, VM containers in the RancherVM system can only be moved to a new platform if the new platform is equipped with an operating system which includes the KVM module.

It has now been found that the foregoing problems may be solved with the systems and methodologies described herein. In a preferred embodiment, these systems and methodologies incorporate a virtualization solution module (which is preferably a KVM module) into each VM container. This approach eliminates the single point of failure found in the RancherVM system (since compromising the KVM module in the systems described herein merely compromises a particular container, not the host system), improves the security of the system, and conveniently allows updates to be implemented at the container level rather than at the system level. Moreover, the VM containers produced in accordance with the teachings herein may be run on any physical platform capable of running virtualization, whether or not the host operating system includes a KVM module, and hence are significantly more portable than the VM containers of the RancherVM system. These and other advantages of the systems and methodologies described herein may be further appreciated from the following detailed description.

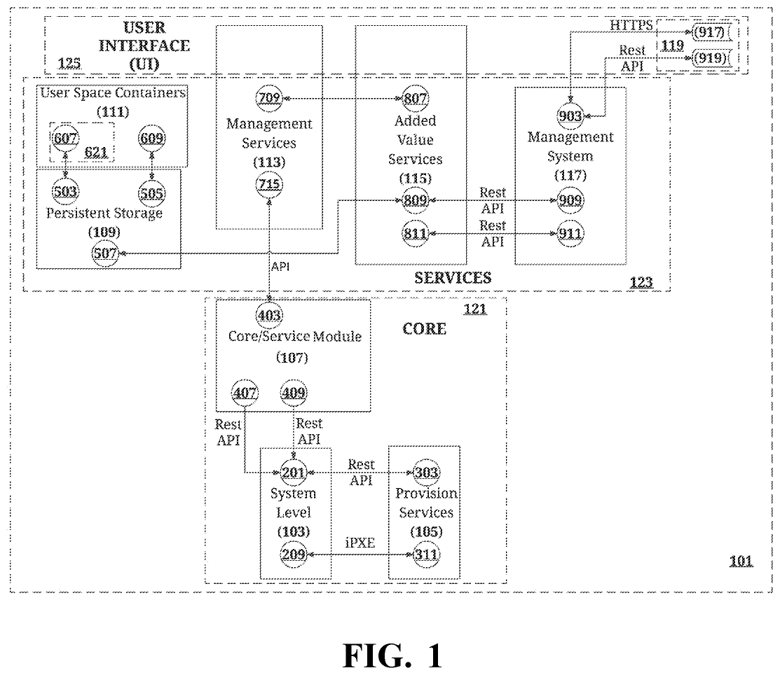

FIGS. 1-9 illustrate a first particular, non-limiting embodiment of a system in accordance with the teachings herein.

With reference to FIG. 1, the system depicted therein comprises a system level module 103, a provision services module 105, a core/service module 107, a persistent storage module 109, a user space containers module 111, a management services module 113, an added value services module 115, a management system module 117, and input/output devices 119. As explained in greater detail below, these modules interact with each other (either directly or indirectly) via suitable application programming interfaces, protocols or environments to accomplish the objectives of the system.

From a top level perspective, the foregoing modules interact to provide a core layer 121, a services layer 123 and a user interface (UI) layer 125, it being understood that some of the modules provide functionality to more than one of these layers. It will also be appreciated that these modules may be reutilized (that is, the preferred embodiment of the systems described herein is a write once, use many model).

The core layer 121 is a hardware layer that provides all of the services necessary to start the operating system. It provides the ability to update the system and provides some security features. The services layer 123 provides all of the services. The UI layer 125 provides the user interface, as well as some REST API calls. Each of these layers has various application program interfaces (APIs) associated with them. Some of these APIs are representational state transfer (REST) APIs, known variously as RESTful APIs or REST APIs.

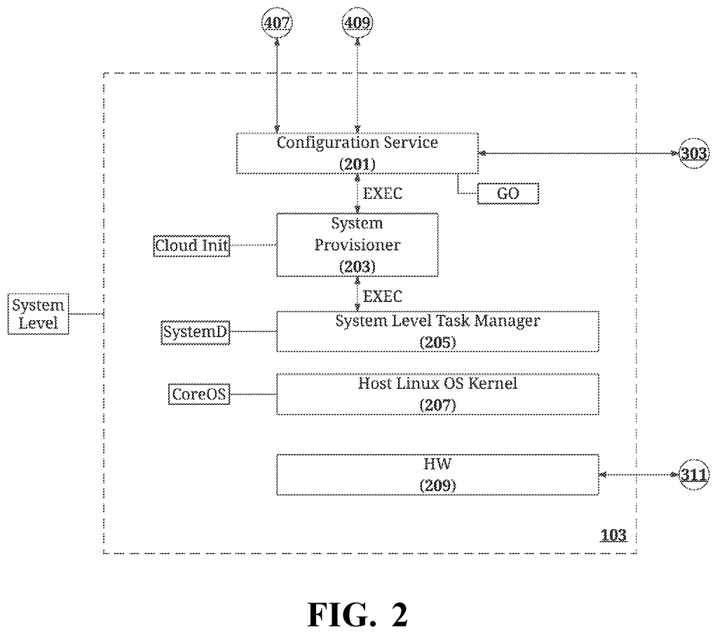

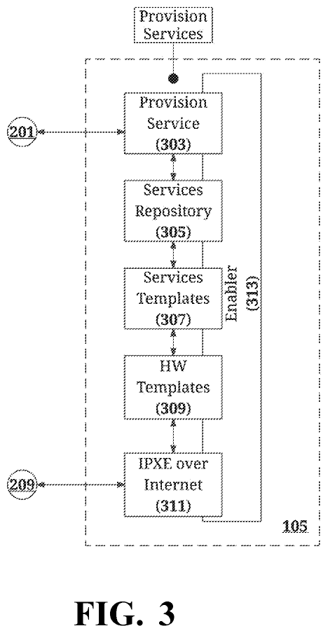

As seen in FIG. 2, the system level module 103 includes a configuration service 201, a system provisioner 203, a system level task manager 205, a host Linux OS kernel 207, and a hardware layer 209. The configuration service 201 is in communication with the configurations database 407 (see FIG. 3), the provision administrator 409 (see FIG. 3) and the provision service 303 (see FIG. 3) through suitable REST APIs. The configuration service 201 and system provisioner 203 interface through suitable exec functionalities. Similarly, the system provisioner 203 and the system level task manager 205 interface through suitable exec functionalities.

The hardware layer 209 of the system level module 103 is designed to support various hardware platforms.

The host Linux OS kernel 207 (CoreOS) component of the system level module 103 preferably includes an open-source, lightweight operating system based on the Linux kernel and designed for providing infrastructure to clustered deployments. The host Linux OS kernel 207 provides advantages in automation, ease of applications deployment, security, reliability and scalability. As an operating system, it provides only the minimal functionality required for deploying applications inside software containers, together with built-in mechanisms for service discovery and configuration sharing.

The system level task manager 205 is based on systemd, an init system used by some Linux distributions to bootstrap the user space and to subsequently manage all processes. As such, the system level task manager 205 implements a daemon process that is the initial process activated during system boot, and that continues running until the system 101 is shut down.

The system provisioner 203 is a cloud-init system (such as the Ubuntu package) that handles early initialization of a cloud instance. The cloud-init system provides a means by which a configuration may be sent remotely over a network (such as, for example, the Internet). If the cloud-init system is the Ubuntu package, it is installed in the Ubuntu Cloud Images and also in the official Ubuntu images which are available on EC2. It may be utilized to configure setting a default locale, setting a hostname, generating ssh private keys, adding ssh keys to a user's .ssh/authorized_keys so they can log in, and setting up ephemeral mount points. It may also be utilized to provide license entitlements, user authentication, and the support purchased by a user in terms of configuration options. The behavior of the system provisioner 203 may be configured via user-data, which may be supplied by the user at instance launch time.

The configuration service 201 keeps the operating system and services updated. This service (which, in the embodiment depicted, is written in the programming language GO) allows for the rectification of bugs or the implementation of system improvements. It provides the ability to connect to the cloud, check if a new version of the software is available and, if so, to download, configure and deploy the new software. The configuration service 201 is also responsible for the initial configuration of the system. The configuration service 201 may be utilized to configure multiple servers in a chain-by-chain manner. That is, after the configuration service 201 is utilized to configure a first server, it may be utilized to resolve any additional configurations of further servers.

The configuration service 201 also checks the health of a running container. In the event that the configuration service 201 daemon determines that the health of a container has been compromised, it administers a service to rectify the health of the container. The latter may include, for example, rebooting or regenerating the workload of the container elsewhere (e.g., on another machine, in the cloud, etc.). A determination that a container has been compromised may be based, for example, on the fact that the container has dropped a predetermined number of pings.

Similarly, such a determination may be made based on TOPS (Input/Output Operations Per Second, which is a measurement of storage speed). For example, when a storage connectivity is made and a query is performed in the TOPS, if the TOPS drops below a certain level as defined in the configuration, it may be determined that the storage is too busy, unavailable or latent, and the connectivity may be moved to faster storage.

Likewise, such a determination may be made based on security standard testing. For example, during testing for a security standard in the background, it may be determined that a port is opened that should not be opened. It may then be assumed that the container was hacked or is an improper type (for example, a development container which lacks proper security provisions may have been placed into a host). In such a case, the container may be stopped and started and subject to proper security filtration as the configuration may apply.

Similarly, such a determination may be made when a person logs on as a specific user, the specific user authentication is denied or does not work, and the authentication is relevant to a micro service or web usage (e.g., not a user of the whole system). This may be because the system has been compromised, the user has been deleted or the password has been changed.

As seen in FIG. 3, the provision services module 105 includes a provision service 303, a services repository 305, services templates 307, hardware templates 309, an iPXE over Internet 311 submodule, and an enabler 313. The enabler 313 interfaces with the remaining components of the provision services module 105. The provision service 303 interfaces with the configuration service 201 of the system level module 103 (see FIG. 2) via a REST API. Similarly, the iPXE over Internet 311 submodule interfaces with the hardware layer 209 of the system level module 103 (see FIG. 2) via an iPXE.

The iPXE over Internet 311 submodule includes Internet-enabled open source network boot firmware which provides a full pre-boot execution environment (PXE) implementation. The PXE is enhanced with additional features to enable booting from various sources, such as booting from a web server (via HTTP), booting from an iSCSI SAN, booting from a Fibre Channel SAN (via FCoE), booting from an AoE SAN, booting from a wireless network, booting from a wide-area network, or booting from an Infiniband network. The iPXE over Internet 311 submodule further allows the boot process to be controlled with a script.

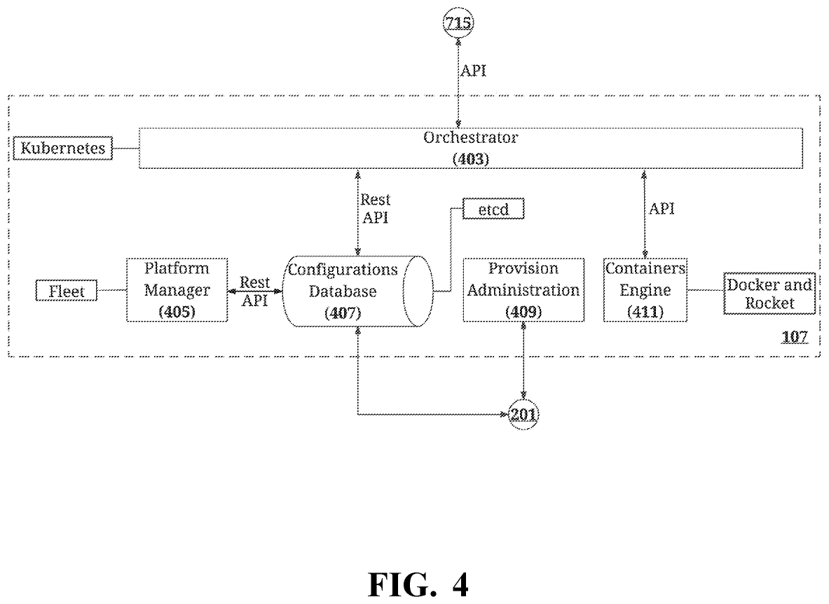

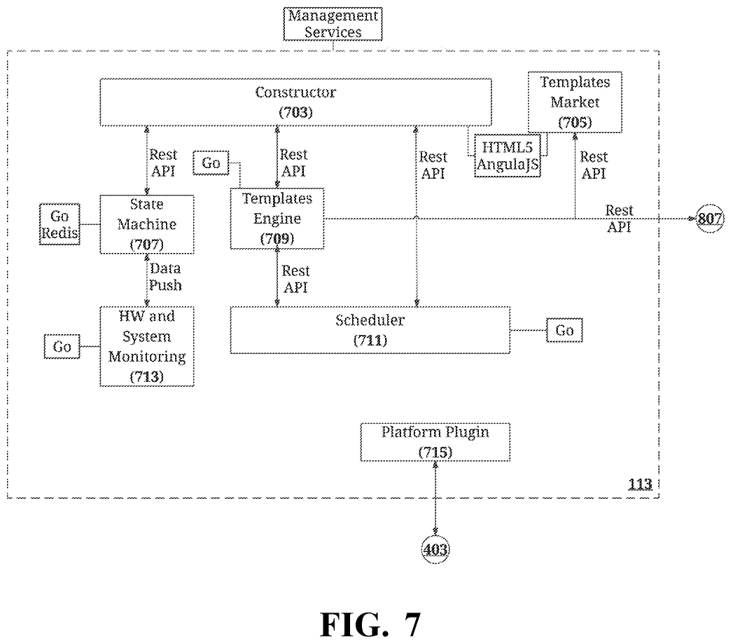

As seen in FIG. 4, the core/service module 107 includes an orchestrator 403, a platform manager 405, a configurations database 407, a provision administration 409, and a containers engine 411. The orchestrator 403 is in communication with the platform plugin 715 of the management services module 113 (see FIG. 7) through a suitable API. The configurations database 407 and the provision administrator 409 are in communication with the configuration service 201 of the system level module 103 (see FIG. 2) through suitable REST APIs.

The orchestrator 403 is a container orchestrator, that is, a connection to a system that is capable of installing and coordinating groups of containers known as pods. The particular, non-limiting embodiment of the core/service module 107 depicted in FIG. 4 utilizes the Kubernetes container orchestrator. The orchestrator 403 handles the timing of container creation, and the configuration of containers in order to allow them to communicate with each other.

The orchestrator 403 acts as a layer above the containers engine 411, the latter of which is typically implemented with Docker and Rocket. In particular, while Docker operation is limited to actions on a single host, the Kubernetes orchestrator 403 provides a mechanism to manage large sets of containers on a cluster of container hosts.

Briefly, a Kubernetes cluster is made up of three major active components: (a) the Kubernetes app-service; the Kubernetes kubelet agent, and the etcd distributed key/value database. The app-service is the front end (e.g., the control interface) of the Kubernetes cluster. It acts to accept requests from clients to create and manage containers, services and replication controllers within the cluster.

etcd is an open-source distributed key value store that provides shared configuration and service discovery for CoreOS clusters. etcd runs on each machine in a cluster, and handles master election during network partitions and the loss of the current master. Application containers running on a CoreOS cluster can read and write data into etcd. Common examples are storing database connection details, cache settings and feature flags. The etcd services are the communications bus for the Kubernetes cluster. The app-service posts cluster state changes to the etcd database in response to commands and queries.

The kubelets read the contents of the etcd database and act on any changes they detect. The kubelet is the active agent. It resides on a Kubernetes cluster member host, polls for instructions or state changes, and acts to execute them on the host. The configurations database 405 is implemented as an etcd database.

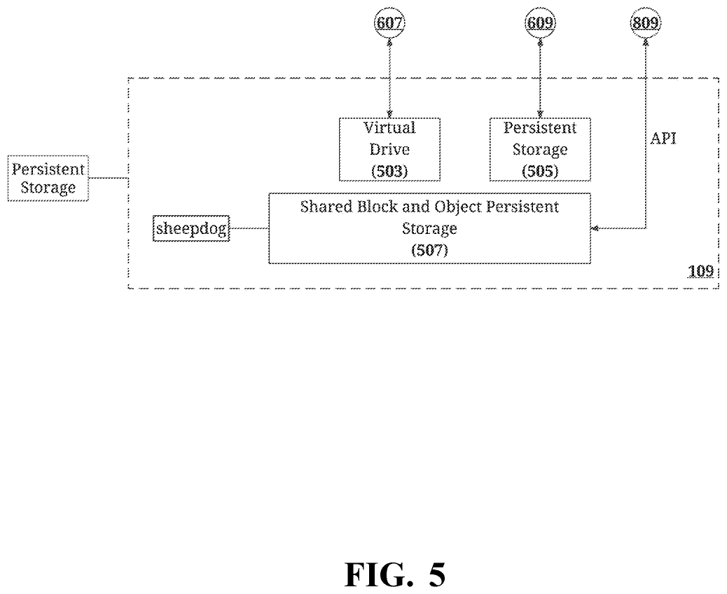

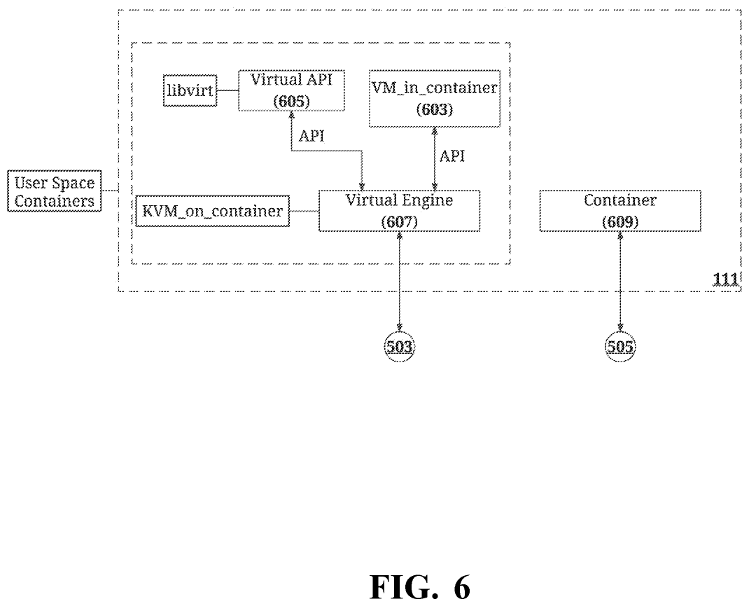

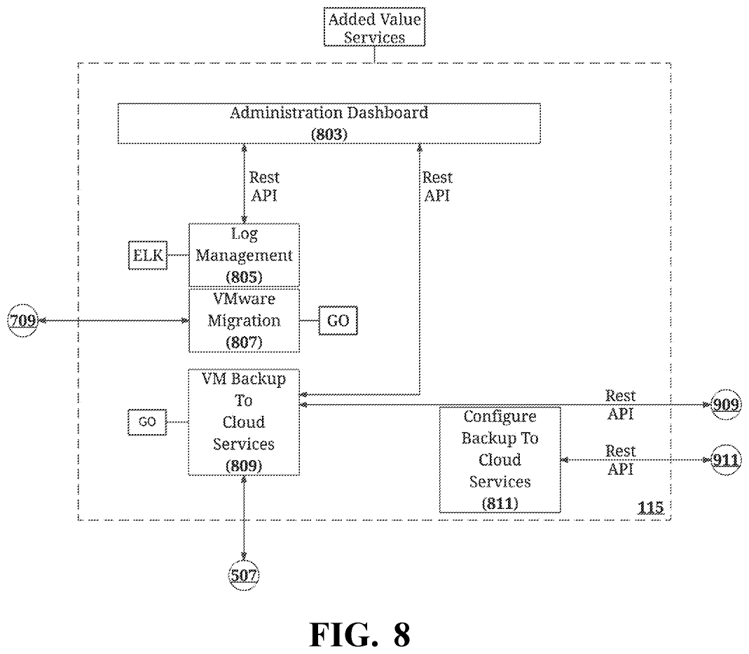

As seen in FIG. 5, the persistent storage module 109 includes a virtual drive 503, persistent storage 505, and shared block and object persistent storage 507. The virtual drive 503 interfaces with the virtual engine 607 of the user space containers module 111 (see FIG. 6), the persistent storage 505 interfaces with container 609 of the user space containers module 111 (see FIG. 6), and the shared block and object persistent storage 507 interfaces (via a suitable API) with the VM backup to cloud services 809 of the added value services module 115 (see FIG. 8). It will be appreciated that the foregoing description relates to a specific use case, and that backup to cloud is just one particular function that the shared block and object persistent storage 507 may perform. For example, it could also perform restore from cloud, backup to agent, and upgrade machine functions, among others.

As seen in FIG. 6, the user space containers module 111 includes a container 609 and a submodule containing a virtual API 605, a VM_in_container 603, and a virtual engine 607. The virtual engine 607 interfaces with the virtual API 605 through a suitable API. Similarly, the virtual engine 607 interfaces with the VM_in_container 603 through a suitable API. The virtual engine 607 also interfaces with the virtual drive 503 of the persistent storage module 109 (see FIG. 5). Container 609 interfaces with the persistent storage 505 of the persistent storage module 109 (see FIG. 5).

As seen in FIG. 7, the management services module 113 includes constructor 703, a templates market 705, a state machine 707, a templates engine 709, a hardware (HW) and system monitoring module 713, a scheduler 711, and a platform plugin 715. The state machine 707 interfaces with the constructor 703 through a REST API, and interfaces with the HW and system monitoring module 713 through a data push. The templates engine 709 interfaces with the constructor 703, scheduler 711 and templates market 705 through suitable REST APIs. Similarly, the templates engine 709 interfaces with the VMware migration module 807 of the value services module 115 (see FIG. 8) through a REST API. The platform plugin 715 interfaces with the orchestrator 403 of the core/service module 107 through a suitable API.

As seen in FIG. 8, the added value services module 115 in the particular embodiment depicted includes an administration dashboard 803, a log management 805, a VMware migration module 807, a VM backup to cloud services 809, and a configuration module 811 to configure a backup to cloud services (here, it is to be noted that migration and backup to cloud services are specific implementations of the services module 115). The administration dashboard 803 interfaces with the log management 805 and the VM backup to cloud services 809 through REST APIs. In some embodiments, a log search container may be provided which interfaces with the log management 805 for troubleshooting purposes.

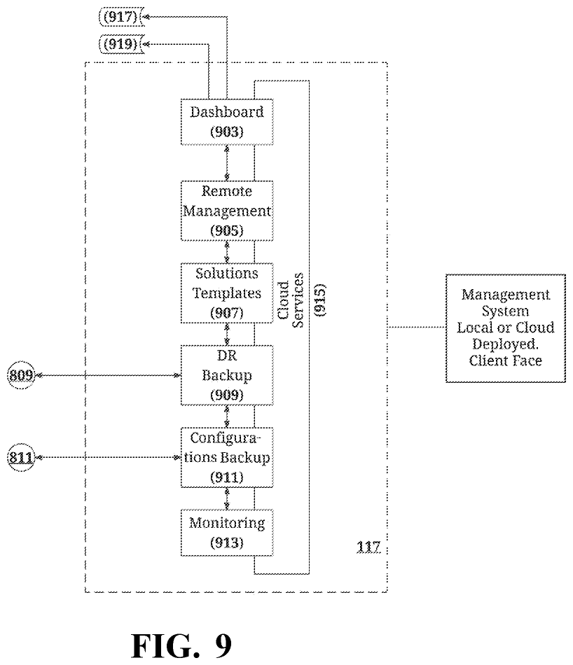

The VMware migration module 807 interfaces with the templates engine 709 of the management services module 113 (see FIG. 7) via a REST API. The VM backup to cloud services 809 interfaces with the shared block and object persistent storage 507 via a suitable API. The VM backup to cloud services 809 interfaces with the DR backup 909 of the management system module 117 (see FIG. 9) via a REST API. The configuration module 811 to configure a backup to cloud services interfaces with the configurations backup 911 of the management system module 117 (see FIG. 9) via a REST API.

As seen in FIG. 9, the management system module 117 includes a dashboard 903, remote management 905, solutions templates 907, a disaster and recovery (DR) backup 909, a configurations backup 911, a monitoring module 913, and cloud services 915. The cloud services 915 interface with all of the remaining components of the management system module 117. The dashboard 903 interfaces with external devices 917, 919 via suitable protocols or REST APIs. The DR backup 909 interfaces with the VM backup to cloud services 809 via a REST API. The configurations backup 911 interfaces with configuration module 811 via a REST API.

The input/output devices 119 include the various devices 917, 919 which interface with the system 101 via the management system module 117. As noted above, these interfaces occur via various APIs and protocols.

The systems and methodologies disclosed herein may leverage at least three different modalities of deployment. These include: (1) placing a virtual machine inside of a container; (2) establishing a container which runs its own workload (in this type of embodiment, there is typically no virtual machine, since the container itself is a virtual entity that obviates the need for a virtual machine); or (3) defining an application as a series of VMs and/or a series of containers that, together, form what would be known as an application. While typical implementations of the systems and methodologies disclosed herein utilize only one of these modalities of deployment, embodiments are possible which utilize any or all of the modalities of deployment.

The third modality of deployment noted above may be further understood by considering its use in deploying an application such as the relational database product Oracle 9i. Oracle 9i is equipped with a database, an agent for connecting to the database, a security daemon, an index engine, a security engine, a reporting engine, a clustering (or high availability in multiple machines) engine, and multiple widgets. In a typical installation of Oracle 9i on a conventional server, it is typically necessary to install several (e.g., 10) binary files which, when started, interact to implement the relational database product.

However, using the third modality of deployment described herein, these 10 services may be run as containers, and the combination of 10 containers running together would mean that Oracle is running successfully on the box. In a preferred embodiment, a user need only take an appropriate action (for example, dragging the word “Oracle” from the left to the right across a display) and the system would do all of this (e.g., activate the 10 widgets) automatically in the background.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hyper-converged system, comprising:
an operating system;
a core layer equipped with hardware which starts and updates the operating system and which provides security features to the operating system;
a services layer which provides services utilized by the operating system and which interfaces with the core layer by way of at least one application program interface; and
a user interface layer which interfaces with the core layer by way of at least one application program interface;
wherein said services layer is equipped with at least one user space having a plurality of containers.

2. The system of claim 1, wherein each of said plurality of containers contains a virtual machine.

3. The system of claim 1, wherein at least one of said plurality of containers runs its own workload.

4. The system of claim 1, wherein said plurality of containers define an application.

5. The system of claim 1, wherein said plurality of containers contains a virtual machine, and wherein the plurality of virtual machines defines an application.

6. The system of claim 1, wherein said core layer includes a system level, and wherein said system level comprises an operating system kernel.

7. The system of claim 6, wherein said operating system kernel is a host Linux operating system kernel.

8. The system of claim 6, wherein said operating system kernel provides infrastructure for clustered deployments.

9. The system of claim 6, wherein said operating system kernel provides functionality for deploying applications inside software containers.

10. The system of claim 9, wherein said operating system kernel further provides mechanisms for service discovery and configuration sharing.

11. The system of claim 6, wherein said system level further comprises a hardware layer.

12. The system of claim 8, wherein said system level further comprises a system level task manager.

13. The system of claim 12, wherein said system level task manager implements a daemon process, wherein said daemon process is the initial process activated during system boot, and wherein said daemon process continues until the system is shut down.

14. The system of claim 6, wherein said system level further comprises a system provisioner that handles early initialization of a cloud instance.

15. The system of claim 6, wherein said system provisioner provides a means by which a configuration may be sent over a network.

16. The system of claim 6, wherein said system provisioner configures at least one service selected from the group consisting of: setting a default locale, setting a hostname, generating ssh private keys, adding ssh keys to a user's authorized keys, and setting up ephemeral mount points.

17. The system of claim 6, wherein said system provisioner provides at least one service selected from the group consisting of: license entitlements, user authentication, and the support purchased by a user in terms of configuration options.

18. The system of claim 6, wherein the behavior of said system provisioner may be configured via data supplied by the user at instance launch time.

19. The system of claim 12, wherein said system provisioner interfaces with said system level task manager by way of at least one exec function.

20. The system of claim 12, wherein said system provisioner interfaces with said system level task manager by way of at least one exec function.

21. The system of claim 6, wherein said system level further comprises a configuration service that updates the operating system.

22. The system of claim 21, wherein said configuration service connects to the cloud, checks if a new version of software is available for the system and, if so, downloads, configures and deploys the new software.

23. The system of claim 21, wherein said configuration service is responsible for the initial configuration of the system.

24. The system of claim 21, wherein said configuration service configures multiple servers in a chain-by-chain manner.

25. The system of claim 21, wherein said configuration service monitors the health of running containers.

26. The system of claim 25, wherein said configuration service rectifies the health of any running containers whose health has been compromised.

27. The system of claim 26, wherein said configuration service rectifies the health, of any running containers whose health has been compromised, by rebooting the container.

28. The system of claim 26, wherein said configuration service rectifies the health, of any running containers whose health has been compromised, by regenerating the workload of the container elsewhere.

29. The system of claim 26, wherein said configuration service determines that the health of a running container has been compromised by determining that the number of pings the container has dropped exceed a threshold value.

30. The system of claim 26, wherein said configuration service determines that the health of a running container has been compromised by determining that the TOPS of the container has dropped below a threshold value.

31. The system of claim 26, wherein said configuration service determines that the health of a running container has been compromised by subjecting the container to security standard testing.

32. The system of claim 26, wherein said configuration service determines that the health of a running container has been compromised by determining that a specific user authentication has been denied or does not work.
